(19) United States
(12) Patent Application Publication
(10) Pub. No.: US 2022/0036386 A1
(43) Pub. Date: Feb. 3, 2022

(54) SUBSCRIPTION RENEWAL PREDICTION WITH A COOPERATIVE COMPONENT

(71) Applicant: Intuit Inc., Mountain View, CA (US)

(72) Inventors: Yair Horesh, Kfar Sava (IL); Onn Bar, Raanan (IL); Gilaad Dital, Hod Hasharon (IL)

(73) Assignee: Intuit Inc., Mountain View, CA (US)

(21) Appl. No.: 16/942,226

(22) Filed: Jul. 29, 2020

(51) Int. Cl. G06Q 30/02; G06N 20/00

(52) U.S. Cl. CPC G06Q 30/0202; G06N 20/00; G06Q 30/0201

(57) ABSTRACT

A method may include detecting, in transactions of initial users, open recurring expense sequences each having expense sequence attributes, deriving, using the expense sequence attributes of the open recurring expense sequences, recurring expense groups each including a subset of the initial users, generating a prediction that the open recurring expense sequences of a recurring expense group will terminate within a period of a current period, grouping, using personal attributes of the users in the recurring expense group, the recurring expense group into recurring expense subgroups, generating, using a trained model, scores for the recurring expense subgroups each indicating a probability that the open recurring expense sequences of the respective recurring expense subgroup are extendable beyond the current period, and selecting, using the scores for the recurring expense subgroups, a recurring expense subgroup to attempt an extension of the open recurring expense sequences of the recurring expense subgroup.

### BACKGROUND

Users of subscription-based services may incur recurring expenses corresponding to the subscription-based services. There is often a grace period associated with such recurring expenses where the services are offered at a reduced rate. For example, new subscribers are typically offered a promotional reduced rate. Once the grace period expires, the rate typically increases, and individual users may lack sufficient leverage to negotiate an extension of the grace period or a new promotional rate.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method including detecting, in transactions of initial users, open recurring expense sequences each having expense sequence attributes, deriving, using the expense sequence attributes of the open recurring expense sequences, recurring expense groups each including a subset of the initial users, generating a prediction that the open recurring expense sequences of a recurring expense group will terminate within a period of a current period, grouping, using personal attributes of the users in the recurring expense group, the recurring expense group into recurring expense subgroups, generating, using a trained model, scores for the recurring expense subgroups each indicating a probability that the open recurring expense sequences of the respective recurring expense subgroup are extendable beyond the current period, and selecting, using the scores for the recurring expense subgroups, a recurring expense subgroup to attempt an extension of the open recurring expense sequences of the recurring expense subgroup.

In general, in one aspect, one or more embodiments relate to a system including a memory coupled to a computer processor and a repository configured to store transactions of initial users, and open recurring expense sequences each having expense sequence attributes. The system further includes a subscription renewal engine executing on the computer processor and using the memory configured to detect, in the transactions of initial users, open recurring expense sequences each having expense sequence attributes, derive, using the expense sequence attributes of the open recurring expense sequences, recurring expense groups each including a subset of the initial users, generate a prediction that the open recurring expense sequences of a recurring expense group will terminate within a period of a current period, group, using personal attributes of the users in the recurring expense group, the recurring expense group into recurring expense subgroups, generate, using a trained model, scores for the recurring expense subgroups each indicating a probability that the open recurring expense sequences of the respective recurring expense subgroup are extendable beyond the current period, and select, using the scores for the recurring expense subgroups, a recurring expense subgroup to attempt an extension of the open recurring expense sequences of the recurring expense subgroup.

In general, in one aspect, one or more embodiments relate to a method including receiving, from a user and via a graphical user interface (GUI), transactions of the user, sending the transactions of the user to a subscription renewal engine performing machine learning and configured to detect, in transactions of initial users, open recurring expense sequences each having expense sequence attributes, derive, using the expense sequence attributes of the open recurring expense sequences, recurring expense groups each including a subset of the initial users, generate a prediction that the open recurring expense sequences of a recurring expense group will terminate within a period of a current period, group, using personal attributes of the users in the recurring expense group, the recurring expense group into recurring expense subgroups, generate, using a trained model, scores for the recurring expense subgroups each indicating a probability that the open recurring expense sequences of the respective recurring expense subgroup are extendable beyond the current period, select, using the scores for the recurring expense subgroups, a recurring expense subgroup to attempt an extension of the open recurring expense sequences of the recurring expense subgroup, and send, to the user and via the GUI, a predicted sequence termination message including the prediction and an invitation for the user to receive a subgroup contact list including contact information of the users in the recurring expense subgroup. The method further includes receiving, from the subscription renewal engine and via the GUI, the predicted sequence termination message, and displaying, in an element within the GUI generated by a computer processor, the predicted sequence termination message.

Other aspects of the invention will be apparent from the following description and the appended claims.

### BRIEF DESCRIPTION OF DRAWINGS

FIG. 1A, FIG. 1B, and FIG. 1C show a system in accordance with one or more embodiments of the invention.

FIG. 2, FIG. 3A, and FIG. 3B show flowcharts in accordance with one or more embodiments of the invention.

FIG. 4A, FIG. 4B, and FIG. 4C show examples in accordance with one or more embodiments of the invention.

FIG. 5A and FIG. 5B show computing systems in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Tracking recurring expenses corresponding to subscription-based services is often challenging for users. In addition, predicting when reduced (e.g., promotional) rates for subscription-based services will expire may be difficult, resulting in an unexpected price increase. Furthermore, an individual user lacks leverage with the vendor when negotiating an extension of a subscription rate.

The disclosed invention provides a new capability for predicting when recurring expense sequences are likely to terminate, augmented with a capability for forming a user group likely to succeed in negotiating an extension of the recurring expense sequences. Each recurring expense sequence is a sequence of transactions involving a user and the same vendor occurring at regular intervals for substantially the same amount. Recurring expense groups may be formed that include subsets of users corresponding to a common set of expense sequence attributes. For example, a recurring expense group may be a subset of users corresponding to the following expense sequence attributes: starting period “June 2020”, vendor ID “vendor123”, amount $25, sequence length “5 months”. A prediction that the open recurring expense sequences of a recurring expense group will terminate may be generated by identifying another recurring expense group with matching expense sequence attributes whose corresponding recurring expense sequences have terminated in the previous time period (e.g., the previous month).

A recurring expense group may be grouped into recurring expense subgroups using personal attributes of the users in the recurring expense group. For example, a recurring expense subgroup may be a subset of users corresponding to the following combination of personal attributes: first three zip code digits “777” and first three industry code digits “456”. Scores for the recurring expense subgroups may be generated using a trained model. The trained model may learn the relationship between different combinations of personal attributes and a probability of successfully extending recurring expense sequences. Each score may indicate a probability that the open recurring expense sequences of the respective recurring expense subgroup are extendable beyond the current period. Using the scores, a recurring expense subgroup may then be selected to attempt an extension of the open recurring expense sequences of the recurring expense subgroup. For example, the selected recurring expense subgroup may negotiate the extension, as a group, with the vendor providing the product or service corresponding to the open recurring expense sequences.

Thus, the selected recurring expense subgroup may be more likely to avoid price increases by successfully extending their corresponding open recurring expense sequences, potentially resulting in savings for the users of the selected recurring expense subgroup. As a result, user satisfaction may be improved, potentially resulting in increased product engagement, positive customer ratings, and an increased sales.

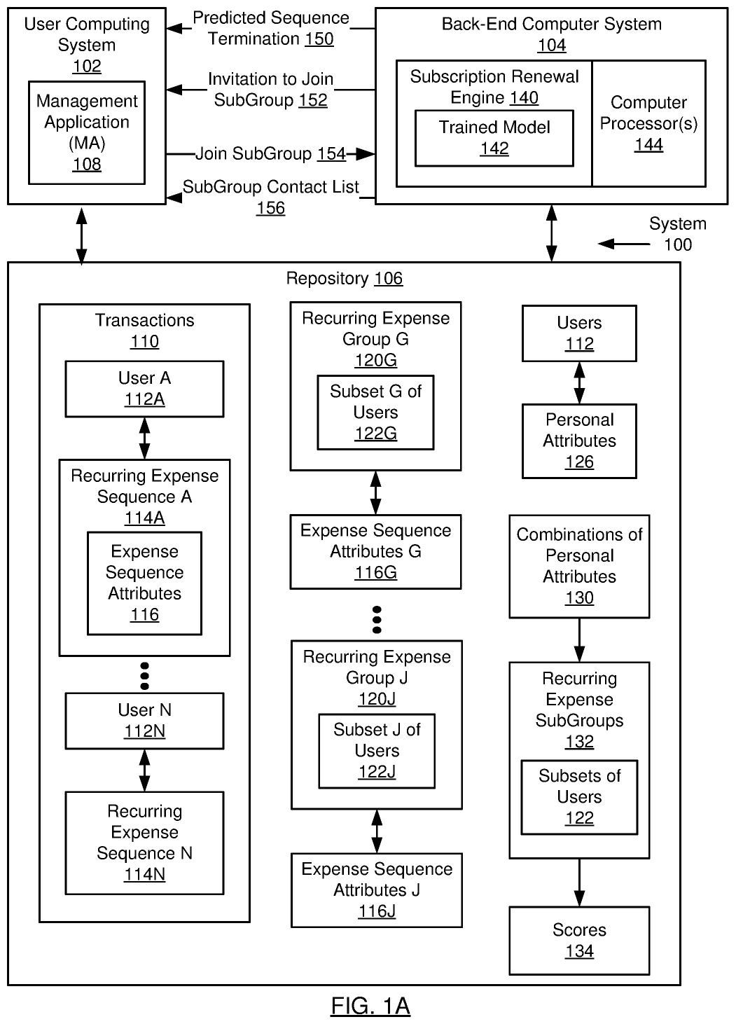

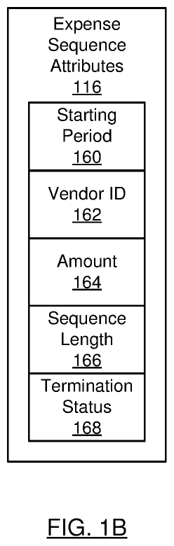

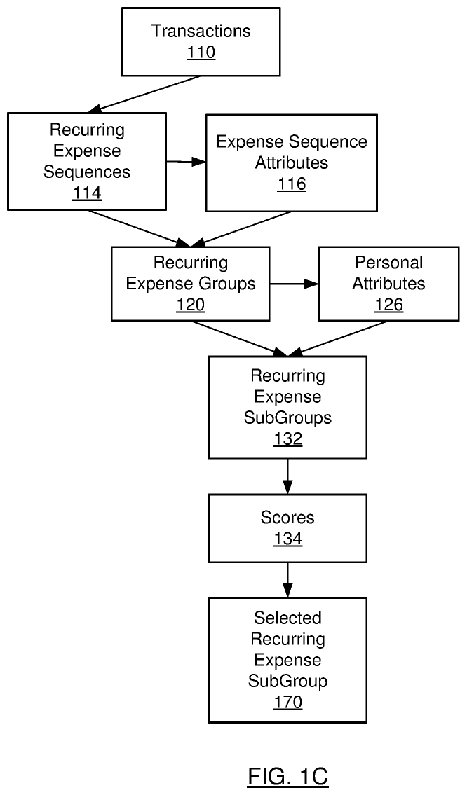

FIG. 1A shows a diagram of a system (100) in accordance with one or more embodiments. As shown in FIG. 1A, the system (100) includes multiple components such as the user computing system (102), a back-end computer system (104), and a repository (106). Each of these components is described below.

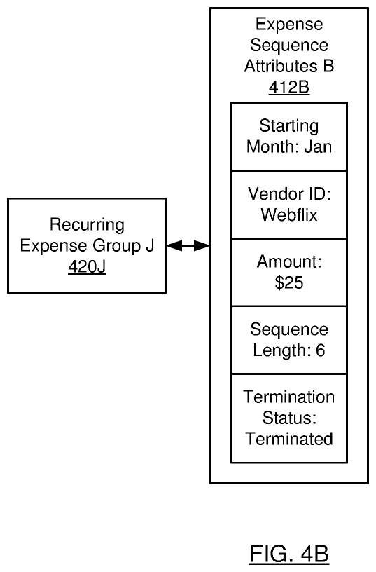

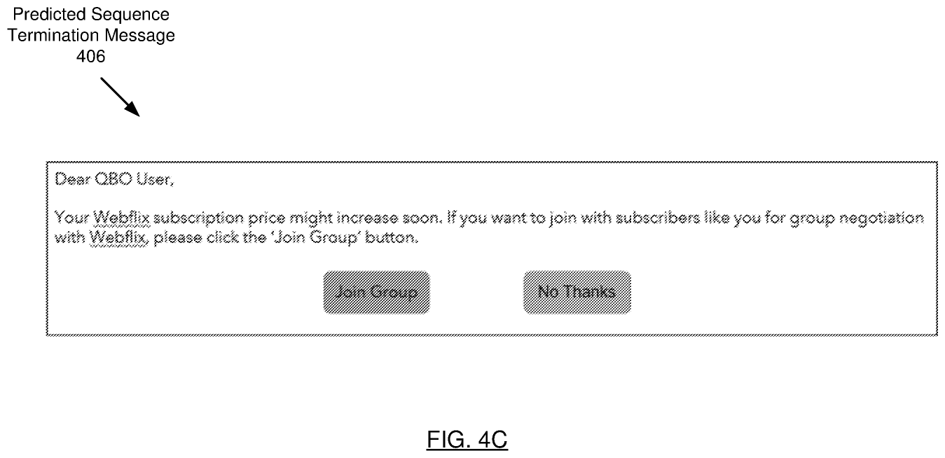

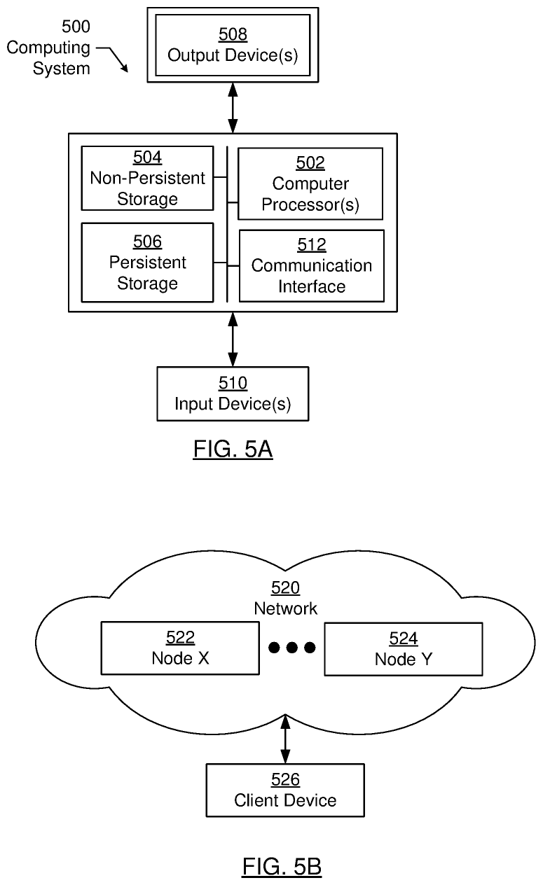

In one or more embodiments, the user computing system (102) provides, to a user, a variety of computing functionality. For example, the computing functionality may include word processing, multimedia processing, financial management, business management, social network connectivity, network management, and/or various other functions that a computing device performs for a user. The user may be a small business owner. Alternatively, the user may be a company employee that acts as a sender, a potential sender, or a requestor of services performed by a company (e.g., a client, a customer, etc.) of the user computing system. The user computing system (102) may be a mobile device (e.g., phone, tablet, digital assistant, laptop, etc.) or any other computing device (e.g., desktop, terminal, workstation, etc.) with a computer processor (not shown) and memory (not shown) capable of running computer software. The user computer system (102) may take the form of the computing system (500) shown in FIG. 5A connected to a network (520) as shown in FIG. 5B.

The user computing system (102) includes a management application (MA) (108) in accordance with one or more embodiments. The MA (108), in accordance with one or more embodiments, is a software application written in any programming language that includes executable instructions stored in some sort of memory. The instructions, when executed by one or more processors, enable a device to perform the functions described in accordance with one or more embodiments. In one or more embodiments, the MA (108) is capable of assisting a user with the user's finances or business needs. For example, the MA (108) may be any type of financially-based application such as a tax program, a personal budgeting program, a small business financial program, or any other type of program that assists with finances.

The MA (108) may include a user interface (UI) (not shown) for receiving input from a user (e.g., user (112A)) and transmitting output to the user. For example, the UI may be a graphical user interface or other user interface. The UI may be rendered and displayed within a local desktop software application or the UI may be generated by a remote web server and transmitted to a user's web browser executing locally on a desktop or mobile device. For example, the UI may be an interface of a software application providing the functionality to the user (e.g., a local gaming application, a word processing application, a financial management application, network management application, business management application etc.). In such a scenario, the help menu, popup window, frame, or other portion of the UI may connect to the MA (108) and present output.

Continuing with FIG. 1A, the repository (106) is any type of storage unit and/or device (e.g., a file system, database, collection of tables, or any other storage mechanism) for storing data. Further, the repository (106) may include multiple different storage units and/or devices. The multiple different storage units and/or devices may or may not be of the same type or located at the same physical site. The repository (106) may be accessed online via a cloud service (e.g., Amazon Web Services, Egnyte, Azure, etc.).

In one or more embodiments, the repository (106) includes functionality to store transactions (110), recurring expense groups (120G, 120J), personal attributes (126), and recurring expense subgroups (132). Each of the transactions (110) is a record of an event involving a vendor and a user (112A). Each transaction may include a vendor ID, a date, and an amount. For example, a transaction may record a purchase by a user (112A) from a vendor corresponding to the vendor ID on a specific date for a specific amount. Each user (112A) corresponds to a user identifier (e.g., a unique identifier).

The transactions (110) may include recurring expense sequences (114A, 114N) corresponding to users (112A, 112N). Each recurring expense sequence (114A) corresponds to a recurring expense sequence ID. Each recurring expense sequence (114A) is a sequence of transactions involving a user (112A) and the same vendor occurring at regular intervals for substantially the same amount. For example, the recurring expense sequence (114A) may correspond to monthly payments by the user (112A) to the vendor for a subscription-based service. The subscription-based service may be a utility service (e.g., providing electric power or internet service), an entertainment service, a news service, a food delivery service, etc. For example, the transactions in the recurring expense sequence (114A) may occur in successive months on substantially the same day of the month (e.g., April 14, May 18, June 16, etc.). Continuing this example, the day of the month of the transactions in the recurring expense sequence (114A) may lie within a threshold number of days of a specific day of the month. Further continuing this example, the day of the month may be the 16^{th} and the threshold number of days may be 2 days. Similarly, the transactions in the recurring expense sequence (114A) may include substantially the same amount (e.g., 15.95, 16.01, 16.05, etc.). Continuing this example, the amount of the transactions in the recurring expense sequence (114A) may lie within a threshold percentage of a specific amount. Further continuing this example, the amount may be $16.00 and the threshold amount may be 4 percent.

A recurring expense sequence (114A) may be described in terms of expense sequence attributes (116). Turning to FIG. 1B, expense sequence attributes (116) may include a starting period (160), a vendor ID (162), an amount (164), a sequence length (166), and a termination status (168). The starting period (160) is the period corresponding to the initial transaction in the recurring expense sequence (114A). For example, the starting period (160) may be a month corresponding to the initial transaction in a recurring expense sequence (114A) whose transactions occur monthly. The vendor ID (162) is an identifier of the vendor providing a product or service to the user (112A). For example, the vendor ID (162) may be a name, alphanumeric string, a corporate address, or any combination of identifiers of the vendor. The amount (164) may be a quantity exchanged between the user (112A) and the vendor. For example, the amount (164) may be a dollar amount of money charged by the vendor to the user (112A). The sequence length (166) is the number of transactions in the recurring expense sequence (114A).

The termination status (168) indicates whether the recurring expense sequence (114A) has been terminated. For example, the termination status (168) may be “terminated” once the vendor charges the user (112A) a substantially increased amount for the service. Continuing this example, the substantially increased amount may be an amount that exceeds the previous amount charged by the vendor by more than a threshold percentage (e.g., a threshold percentage of 10 percent). The transaction including the substantially increased amount may be the initial transaction in a new recurring expense sequence. Alternatively, the termination status (168) may be “open” while the vendor continues to charge the user (112A) an amount that is substantially the same as previous amounts of the transactions in the recurring expense sequence (114A).

Returning to FIG. 1A, recurring expense groups (120G, 120J) include subsets of users (122G, 122J) corresponding to a common set of expense sequence attributes (116G, 116J). Each recurring expense group (120G) corresponds to a recurring expense group identifier. Each recurring expense group (120G) is a subset of users (122G) who have a recurring expense sequence with the same expense sequence attributes (116G). For example, a recurring expense group may be a subset of users corresponding to the following expense sequence attributes: starting period “June 2020”, vendor ID “vendor123”, amount $25, sequence length “5 months”, and termination status “open”. Continuing this example, each user in the subset of users has an open (i.e., not yet terminated) recurring expense sequence with vendor123 for $25 that began in June, and has continued for 5 months.

In one or more embodiments, the users (112) correspond to personal attributes (126). The personal attributes (126) include various information about a user. For example, personal attributes (126) may include: zip code, industry code (e.g., North American Industry Classification System (NAICS) code or Merchant Category Code (MCC)), number of employees, company age in years, and/or other publicly available attributes.

In one or more embodiments, recurring expense subgroups (132) are subsets of users (122) corresponding to different combinations of personal attributes (130). Each of the recurring expense subgroups (132) is a subset of a recurring expense group (120G) corresponding to the same combination of personal attributes (130). For example a recurring expense group (120G) may be grouped into recurring expense subgroups (132) using a combination of first three zip code digits and first three digits of an industry code. Continuing this example, one recurring expense subgroup may include users corresponding to the following combination of personal attributes: first three zip code digits “777” and first three industry code digits “456”. One motivation for grouping a recurring expense group (120G) into recurring expense subgroups (132) is to apply a trained model (142) to the recurring expense subgroups (132) to determine whether any of the recurring expense subgroups (132) are more likely to succeed in extending the recurring expense sequences of the corresponding recurring expense subgroup beyond the current period. For example, the users of a recurring expense subgroup may attempt to collectively negotiate an extension of the recurring expense sequences with the vendor providing products or services corresponding to the recurring expense sequences.

The recurring expense subgroups (132) may correspond to scores (134) assigned to the recurring expense subgroups (132) by the trained model (142). Each of the scores (134) may indicate a probability (e.g., a confidence level) that the recurring expense sequences of the corresponding recurring expense subgroup are extendable beyond the current period. Alternatively, each of the recurring expense subgroups (132) may correspond to a series of sub-scores assigned by the trained model (142). Each of the sub-scores may indicate a probability that the recurring expense sequences of the corresponding recurring expense subgroup are extendable by a specific number of periods (e.g., extendable by 3 months, extendable by 6 months, extendable by 9 months, etc.) beyond the current period.

Continuing with FIG. 1A, the back-end computer system (104) may include a subscription renewal engine (140) and computer processor(s) (144). The subscription renewal engine (140) includes functionality to calculate scores (134) for the recurring expense subgroups (132) using a trained model (142). The trained model (142) may be trained using historical records each including an identifier of a recurring expense subgroup (132), a combination of personal attributes common to the recurring expense subgroup (132), and an outcome indicating whether the recurring expense sequences of the corresponding recurring expense subgroup were successfully extended. The trained model (142) may thus learn the relationship between different combinations of personal attributes and a probability of successfully extending the recurring expense sequences. The outcome may be a binary outcome indicating whether or not a majority of the users in the recurring expense subgroup (132) successfully extended their corresponding open recurring expense sequences (e.g., without incurring a substantial increase in the amount charged by the vendor). Alternatively, the outcome may be a continuous outcome indicating the proportion of users in the recurring expense subgroup (132) who successfully extended their corresponding open recurring expense sequences.

In one or more embodiments, each historical record further includes, for those recurring expense subgroups with a successful outcome, the number of periods by which the open recurring expense sequences of the respective recurring expense subgroup were extended. For example, the result of an successful attempt to extend the open recurring expense sequences corresponding to a recurring expense subgroup may be an extension of 6 months. Continuing this example, the extension may represent an average extension, a minimum extension, or a maximum extension of the recurring expense sequences of the users in the recurring expense subgroup. The trained model (142) may thus further learn the relationship between different combinations of personal attributes and a probability of successfully extending the recurring expense sequences by specific numbers of time periods.

In one or more embodiments, each historical record further includes a number of successful users in the recurring expense subgroup who are also included in at least one other recurring expense subgroup with a successful outcome. For example, the scores (134) and/or the sub-scores assigned by the trained model (142) may further be based on the number or proportion of successful users in the respective recurring expense subgroup.

In one or more embodiments, each historical record further includes the vendor ID of the expense sequence attributes corresponding to the recurring expense group (120G) that includes the respective recurring expense subgroup.

The trained model (142) may be implemented as various types of deep learning classifiers and/or regressors based on neural networks (e.g., based on convolutional neural networks (CNNs)), random forests, stochastic gradient descent (SGD), a lasso classifier, gradient boosting (e.g., XGBoost), bagging, adaptive boosting (AdaBoost), ridges, elastic nets, or Nu Support Vector Regression (NuSVR). Deep learning, also known as deep structured learning or hierarchical learning, is part of a broader family of machine learning methods based on learning data representations, as opposed to task-specific algorithms.

Turning to FIG. 1C, the subscription renewal engine (140) includes functionality to detect, in transactions (110) of users, recurring expense sequences (114) each corresponding to expense sequence attributes (116). The subscription renewal engine (140) further includes functionality to derive, from the recurring expense sequences (114), recurring expense groups (120) each including a subset of users and corresponding to the same combination of expense sequence attributes (116) (e.g., starting period “June 2020”, vendor ID “vendor123”, etc.). The subscription renewal engine (140) further includes functionality to divide a selected recurring expense group into recurring expense subgroups (132) using personal attributes (126) (e.g., zip codes, industry codes, etc.) of the users in the selected recurring expense group. The selected recurring expense group may be a recurring expense group whose open recurring expense sequences are predicted to terminate within a period of a current period (e.g., the open recurring expense sequences are predicted to terminate within the next month). The subscription renewal engine (140) further includes functionality to apply a trained model (142) to generates scores (134) for the recurring expense subgroups (132) each indicating a probability that the open recurring expense sequences of the respective recurring expense subgroup are extendable beyond the current period. The subscription renewal engine (140) further includes functionality to select, using the scores (134), a selected recurring expense subgroup (170) to attempt an extension of the open recurring expense sequences of the selected recurring expense subgroup (170). For example, the subscription renewal engine (140) may include functionality to place the users of the selected recurring expense subgroup (170) in contact with one another in order to negotiate, as a group, with the vendor corresponding to the open recurring expense sequences of the selected recurring expense subgroup (170).

The subscription renewal engine (140) includes functionality to send a predicted sequence termination (150) to the management application (MA) (108). The predicted sequence termination (150) is a prediction that the open recurring expense sequences of a recurring expense group (120G) will terminate within a period of a current period. The subscription renewal engine (140) includes functionality to send an invitation to join a subgroup (152) to the MA (108). The invitation to join a subgroup (152) offers, to a user (112A) in a recurring expense subgroup, the opportunity to receive a subgroup contact list (156) including contact information of the other users in the recurring expense subgroup. For example, the users in the recurring expense subgroup may decide to negotiate as a group with the vendor providing the product or service corresponding to the recurring expense sequences of the users in the recurring expense subgroup. The subscription renewal engine (140) includes functionality to receive, from the MA (108), a join subgroup (154) message indicating an acceptance of a user (112A) of the offer to receive the subgroup contact list (156). The subscription renewal engine (140) includes functionality to send, to the MA (108), the subgroup contact list (156).

In one or more embodiments, the computer processor(s) (144) takes the form of the computer processor(s) (502) described with respect to FIG. 5A and the accompanying description below. The computer processor (144) includes functionality to execute the subscription renewal engine (140).

While FIG. 1A shows a configuration of components, other configurations may be used without departing from the scope of the invention. For example, various components may be combined to create a single component. As another example, the functionality performed by a single component may be performed by two or more components.

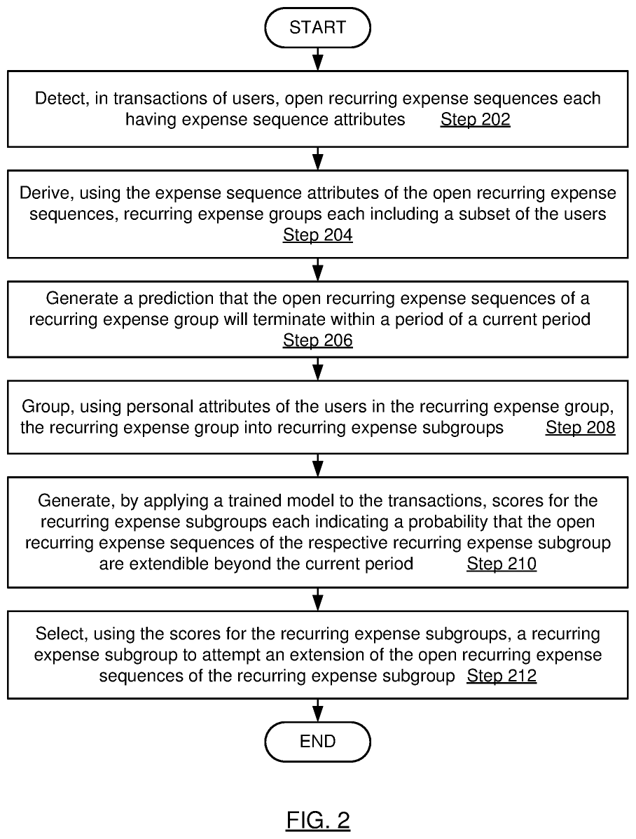

FIG. 2 shows a flowchart in accordance with one or more embodiments of the invention. The flowchart depicts a process for subscription renewal prediction. One or more of the steps in FIG. 2 may be performed by the components (e.g., the subscription renewal engine (140) of the back-end computer system (104) and the management application (MA) (108) of the user computing system (102)), discussed above in reference to FIG. 1A. In one or more embodiments of the invention, one or more of the steps shown in FIG. 2 may be omitted, repeated, and/or performed in parallel, or in a different order than the order shown in FIG. 2. Accordingly, the scope of the invention should not be considered limited to the specific arrangement of steps shown in FIG. 2.

Initially, in Step 202, open recurring expense sequences are detected in transactions of initial users. The transactions may be obtained, over a network from one or more financial institutions such as banks and/or credit card processing companies. In one or more embodiments, the transactions correspond to users of the management application. Each open recurring expense sequence has expense sequence attributes including a termination status of “open” (i.e., the open recurring expense sequence has not yet terminated). The subscription renewal engine may detect the open recurring expense sequences by finding sequences of transactions involving a user and the same vendor occurring at regular intervals for substantially the same amount. In one or more embodiments, each recurring expense sequence includes a number of transactions exceeding a minimum threshold (e.g., a minimum threshold of 5 transactions in a sequence).

In Step 204, recurring expense groups are derived using the expense sequence attributes of the open recurring expense sequences. Each recurring expense group is a subset of initial users who have a recurring expense sequence with the same expense sequence attributes. For example, a recurring expense group may be a subset of users corresponding to the following expense sequence attributes: starting period “June 2020”, vendor ID “vendor123”, amount $25, sequence length “5 months”, and termination status “open”. In one or more embodiments, each recurring expense group includes a number of users exceeding a minimum threshold (e.g., a minimum threshold of 10 users).

In Step 206, a prediction that the open recurring expense sequences of a recurring expense group will terminate within a period of a current period is generated. For example, the prediction may be a prediction that a promotional amount charged by a vendor corresponding to the open recurring expense sequences of the recurring expense group will be increased within a month of a current month. The subscription renewal engine may generate the prediction by identifying one or more other recurring expense groups satisfying the following criteria:

1) the other recurring expense groups correspond to expense sequence attributes that match the expense sequence attributes corresponding to the recurring expense group,

2) the other recurring expense groups correspond to a termination status of “terminated”, and

3) the other recurring expense groups correspond to a sequence length that is one more than the sequence length corresponding to the recurring expense group.

For example, the recurring expense group may correspond to a sequence length of 5 months and the other recurring expense groups may correspond to a sequence length of 6 months. The strength of the prediction may be based on the number of other recurring expense groups satisfying the above criteria.

In Step 208, the recurring expense group is grouped into recurring expense subgroups using personal attributes of the users in the recurring expense group. Each of the recurring expense subgroups is a subset of the recurring expense group corresponding to the same combination of personal attributes. For example, a recurring expense subgroup may be a subset of users corresponding to the following combination of personal attributes: first three zip code digits “777” and first three industry code digits “456”. Because the number of ways to split a group using different combinations of personal attributes may be large, the subscription renewal engine may use heuristics (e.g., rules) to select attributes by which to form the recurring expense subgroups. For example, one heuristic may be to iterate over all pairs of personal attributes.

In Step 210, scores for the recurring expense subgroups are generated using a trained model. Each score may indicate a probability that the open recurring expense sequences of the respective recurring expense subgroup are extendable beyond the current period. The trained model may learn the relationship between different combinations of personal attributes and a probability of successfully extending recurring expense sequences.

Alternatively, a series of sub-scores for the recurring expense subgroups may be generated using the trained model. Each of the sub-scores may indicate a probability that the recurring expense sequences of the corresponding recurring expense subgroup are extendable by a specific number of periods (e.g., 3 months, 6 months, 9 months, etc.) beyond the current period.

In Step 212, a recurring expense subgroup is selected, using the scores for the recurring expense subgroups, to attempt an extension of the open recurring expense sequences of the recurring expense subgroup. For example, the recurring expense subgroup may negotiate the extension, as a group, with the vendor providing the product or service corresponding to the open recurring expense sequences of the recurring expense subgroup. The subscription renewal engine may select the recurring expense subgroup corresponding to the highest score. In one or more embodiments, the subscription renewal engine may select the recurring expense subgroup when the score for the recurring expense subgroup exceeds a threshold score. For example, a threshold score of 0.75 may indicate a 75% confidence level that the recurring expense subgroup will successfully extend the open recurring expense sequences of the recurring expense subgroup.

In one or more embodiments, the subscription renewal engine recommends, to the recurring expense subgroup, a number of periods in the extension of the open recurring expense sequences of the recurring expense subgroup. For example, the number of periods in the extension may be based on a series of sub-scores generated for the recurring expense subgroup using the trained model. Continuing this example, each of the sub-scores may indicate a probability that the recurring expense sequences of the corresponding recurring expense subgroup are extendable by a specific number of periods (e.g., 3 months, 6 months, 9 months, etc.) beyond the current period.

In one or more embodiments, the subscription renewal engine retrains the trained model by adding a new historical record corresponding to the outcome of the attempted extension of the open recurring expense sequences of the recurring expense subgroup. For example, the new historical record may include an identifier of the recurring expense subgroup, the combination of personal attributes common to the recurring expense subgroup, and the outcome. Continuing this example, the outcome may be a binary outcome indicating whether or not a majority of the users in the recurring expense subgroup successfully extended their corresponding open recurring expense sequences without incurring a substantial increase in the amount charged by the vendor. The subscription renewal engine may determine the outcome of the attempted extension of the open recurring expense sequences of the recurring expense subgroup by periodically examining (e.g., after the current period has elapsed) the transactions corresponding to the users in the recurring expense subgroup. For example, the subscription renewal engine may examine the transactions in successive periods until each of the open recurring expense sequences of the recurring expense subgroup has a termination status of “terminated”. Continuing this example, a recurring expense sequence of a user may have a termination status of “terminated” when the amount in a new transaction of the user is increased beyond a threshold percentage (e.g., a substantial price increase has occurred). Alternatively, a recurring expense sequence of the user may have a termination status of “terminated” when a new period elapses and no additional transaction of the user is added to the recurring expense sequence.

In one or more embodiments, when the recurring expense subgroup has a successful outcome, the subscription renewal engine updates the new historical record with a number of periods by which the open recurring expense sequences of the recurring expense subgroup were extended.

In one or more embodiments, the subscription renewal engine recommends an alternate vendor to the recurring expense subgroup. For example, the recurring expense group may correspond to a combination of expense sequence attributes including a vendor ID of a first vendor. The subscription renewal engine may recommend the alternate vendor based on identifying, in the historical records, other recurring expense subgroups with successful outcomes corresponding to combinations of expense sequence attributes including the vendor ID of an alternate vendor in the same industry as the first vendor (e.g., an alternate vendor corresponding to the same industry code as the first vendor). In one or more embodiments, the subscription renewal engine further recommends, to the recurring expense subgroup, a product or service of the alternate vendor (e.g., a product or service charged at an amount substantially the same as the amount charged by the first vendor).

In one or more embodiments, the subscription renewal engine sends, to each user of the recurring expense subgroup, a predicted sequence termination message including the prediction of Step 206 above and an invitation for the user to receive a subgroup contact list including contact information of the users in the first recurring expense subgroup (e.g., so that the users of the recurring expense subgroup may collectively negotiate an extension with the first vendor). The subscription renewal engine may then:
1) send the subgroup contact list to those users who accept the invitation within a predetermined time interval, and
2) generate a modified recurring expense subgroup by removing, from the recurring expense subgroup, any user who does not accept the invitation within the predetermined time interval.

Next, the subscription renewal engine may generate a modified set of users by removing, from the initial set of users (i.e., the users referenced in Step 202 above), the users of the modified recurring expense subgroup. In one or more embodiments, the subscription renewal engine may further remove, from the initial set of users, any user who has already received an invitation to receive a subgroup contact list. For example, sending multiple similar messages to the same user may be considered undesirable. The subscription renewal engine may then repeat the steps of FIG. 2 using the modified set of users. For example, the subscription renewal engine may repeat the following steps:
1) Step 202 above to detect a modified set of open recurring expense sequences in transactions of the modified set of users,
2) Step 204 above to derive a modified set of recurring expense groups using the expense sequence attributes of the modified set of open recurring expense sequences,
3) Step 206 above to generate a prediction that the open recurring expense sequences of a second recurring expense group will terminate within a period of a current period,
4) Step 208 above to group the second recurring expense group into second recurring expense subgroups using personal attributes of the users in the second recurring expense group,
5) Step 210 above to generate scores for the second recurring expense subgroups using the trained model, and
6) Step 212 above to a select a second recurring expense subgroup, using the scores for the second recurring expense subgroups, to attempt an extension of the open recurring expense sequences of the second recurring expense subgroup.

FIG. 3A shows a flowchart in accordance with one or more embodiments of the invention. The flowchart depicts a process for subscription renewal prediction. One or more of the steps in FIG. 3A may be performed by the components (e.g., the subscription renewal engine (140) of the back-end computer system (104) and the management application (MA) (108) of the user computing system (102)), discussed above in reference to FIG. 1A. In one or more embodiments of the invention, one or more of the steps shown in FIG. 3A may be omitted, repeated, and/or performed in parallel, or in a different order than the order shown in FIG. 3A. Accordingly, the scope of the invention should not be considered limited to the specific arrangement of steps shown in FIG. 3A.

Initially, in Step 252, transactions corresponding to a user are received from a user via a graphical user interface (GUI). For example, the GUI may be a GUI of a management application.

In Step 254, the transactions are sent to a subscription renewal engine that performs machine learning and is configured to perform the steps of FIG. 3B. The transactions may be sent to the subscription renewal engine by the management application over a network.

In Step 256, a predicted sequence termination message is received from the subscription renewal engine via the GUI (see description of Step 212 above). In one or more embodiments, the predicted sequence termination message is sent, over the network, by the subscription renewal engine to the user computing system.

In Step 258, the predicted sequence termination message is displayed via an element within the GUI. In one or more embodiments, the element (e.g., a widget) is generated by a computer processor and rendered within the GUI.

FIG. 3B shows a flowchart in accordance with one or more embodiments of the invention. The flowchart depicts a process for subscription renewal prediction. One or more of the steps in FIG. 3B may be performed by the components (e.g., the subscription renewal engine (140) of the back-end computer system (104) and the management application (MA) (108) of the user computing system (102)), discussed above in reference to FIG. 1A. In one or more embodiments of the invention, one or more of the steps shown in FIG. 3B may be omitted, repeated, and/or performed in parallel, or in a different order than the order shown in FIG. 3B. Accordingly, the scope of the invention should not be considered limited to the specific arrangement of steps shown in FIG. 3B.

Initially, in Step 272, open recurring expense sequences are detected in transactions of users (see description of Step 202 above). The users include the user referenced in Step 252 above, and the transactions of users include the transactions received from the user in Step 252 above.

In Step 274, recurring expense groups are derived using the expense sequence attributes of the open recurring expense sequences (see description of Step 204 above).

In Step 276, a prediction that the open recurring expense sequences of a recurring expense group will terminate within a period of a current period is generated (see description of Step 206 above).

In Step 278, the recurring expense group is grouped into recurring expense subgroups using personal attributes of the users in the recurring expense group (see description of Step 208 above).

In Step 280, scores for the recurring expense subgroups are generated using a trained model (see description of Step 210 above).

In Step 282, a recurring expense subgroup is selected, using the scores for the recurring expense subgroups, to attempt an extension of the open recurring expense sequences of the recurring expense subgroup (see description of Step 212 above). The recurring expense subgroup includes the user referenced in Step 252 above.

In Step 284, a predicted sequence termination message is sent to the user referenced in Step 252 above via the GUI (see description of Step 212 above).

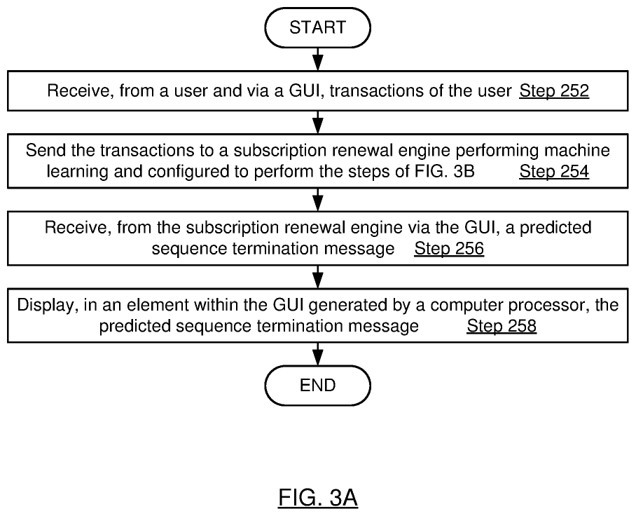

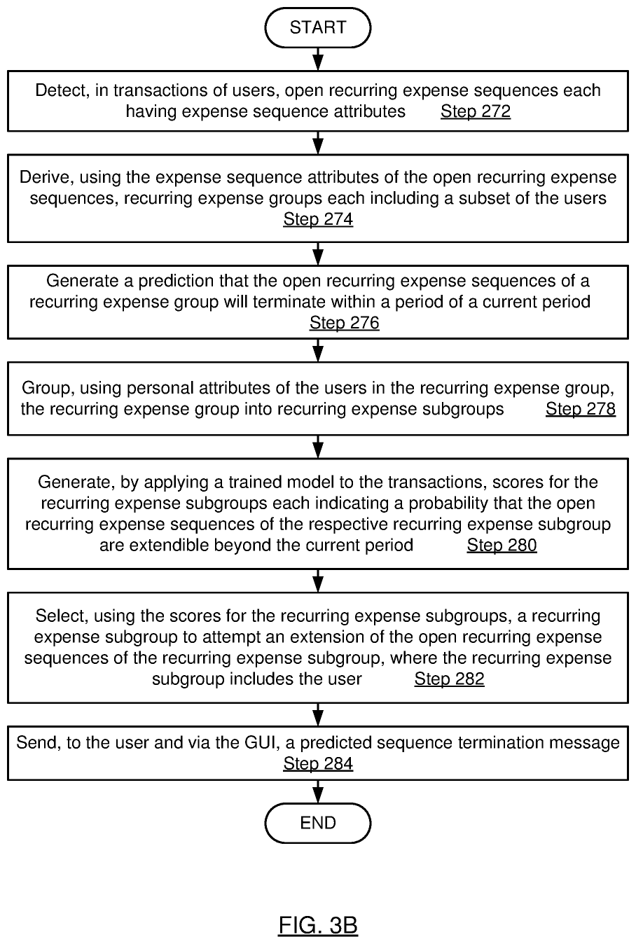

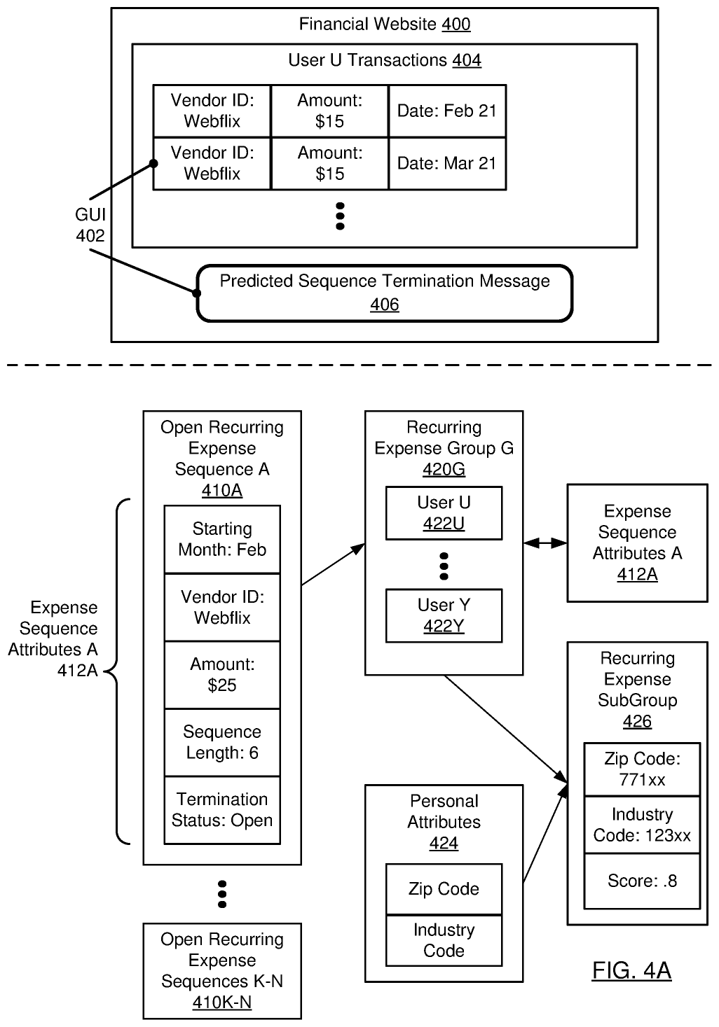

The following example is for explanatory purposes only and not intended to limit the scope of the invention. FIG. 4A, FIG. 4B, and FIG. 4C show an implementation example in accordance with one or more embodiments of the invention. FIG. 4A shows a financial website (400) executing a subscription renewal engine. The subscription renewal engine obtains transactions (404) ((110) in FIG. 1A and FIG. 1C) entered by user U (422U) ((112A, 112N) in FIG. 1A) via a graphical user interface (GUI) (402) (e.g., a GUI of the management application (108) of FIG. 1A) of a user computing system that communicates with the financial website (400) over a network. The subscription renewal engine detects open recurring expense sequence A (410A) ((114A, 114N) in FIGS. 1 A and (114) FIG. 1C) in the transactions (404) of user U (422U). The subscription renewal engine also detects open recurring expense sequences (410K-N) in the transactions of other users (e.g., user Y (422Y)). Each of the open recurring expense sequences (410A, 410K-N) includes expense sequence attributes. For example, open recurring expense sequence A (410A) includes expense sequence attributes A (412A) ((116) in FIG. 1A and FIG. 1C). Then, the subscription renewal engine derives multiple recurring expense groups including recurring expense group G (420G) ((120G, 120J) in FIG. 1A and (120) FIG. 1C). Recurring expense group G (420G) includes users (422U, 422Y) which have open recurring expense sequences with the same expense sequence attributes (412A). That is, recurring expense group G (420G) corresponds to expense sequence attributes A (412A).

Next, the subscription renewal engine identifies recurring expense group J (420J) which corresponds to expense sequence attributes B (412B), as shown in FIG. 4B. Expense sequence attributes B (412B) match expense sequence attributes A (412A), except that the starting month (January) in expense sequence attributes B (412B) is one month earlier than the starting month (February) in expense sequence attributes A (412A) and the termination status in expense sequence attributes B (412B) is “terminated”, while the termination status in expense sequence attributes A (412A) is “open”. The identification of recurring expense group J (420J) is a signal suggesting that the open recurring expense sequences of the users in recurring expense group G (420G) will terminate within a month of the current month of July. Thus, the subscription renewal engine generates a prediction that the open recurring expense sequences of recurring expense group G (420G) will terminate in August.

Next, the subscription renewal engine groups the users of recurring expense group G (420G) into recurring expense subgroups using personal attributes (424) of the users. In this case, the personal attributes (424) include the first three digits of the zip code and the first three digits of an industry code associated with a business of the user. One such recurring expense subgroup is recurring expense subgroup (426). The trained classifier assigns scores to the recurring expense subgroups indicating the probability that the recurring expense sequences of the corresponding recurring expense subgroup are extendable beyond the current period. The trained classifier assigns a score of 0.8 to recurring expense subgroup (426), which is above a threshold score of 0.75. Based on the score exceeding the threshold, the subscription renewal engine then selects recurring expense subgroup (426) to collaboratively attempt an extension of the open recurring expense sequences of the recurring expense subgroup (426) to avoid an increase in the amount of future transactions in the recurring expense sequences. The subscription renewal engine then sends a predicted sequence termination message (406) to the users in recurring expense subgroup (426). FIG. 4C shows an example of the predicted sequence termination message (406).

Embodiments of the invention may be implemented on a computing system.

Any combination of mobile, desktop, server, router, switch, embedded device, or other types of hardware may be used. For example, as shown in FIG. 5A, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (500) may be located at a remote location and connected to the other elements over a network.

Although not shown in FIG. 5B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5A. Further, the client device (526) may include and/or perform all or a portion of one or more embodiments of the invention.

The computing system or group of computing systems described in FIG. 5A and 5B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 5A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The computing system in FIG. 5A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 5A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 5A and the nodes and/or client device in FIG. 5B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
detecting, in transactions of an initial plurality of users, a plurality of open recurring expense sequences each having a plurality of expense sequence attributes;
deriving, using the plurality of expense sequence attributes of the plurality of open recurring expense sequences, a plurality of recurring expense groups each comprising a subset of the initial plurality of users;
generating a first prediction that the open recurring expense sequences of a first recurring expense group of the plurality of recurring expense groups will terminate within a period of a current period;
grouping, using personal attributes of the users in the first recurring expense group, the first recurring expense group into a plurality of recurring expense subgroups;
generating, using a trained model, a plurality of scores for the plurality of recurring expense subgroups each indicating a probability that the open recurring expense sequences of the respective recurring expense subgroup are extendable beyond the current period; and
selecting, using the plurality of scores for the plurality of recurring expense subgroups, a first recurring expense subgroup to attempt an extension of the open recurring expense sequences of the first recurring expense subgroup.

2. The method of claim 1, further comprising:
recommending, to the first recurring expense subgroup, a number of periods in the extension of the open recurring expense sequences of the first recurring expense subgroup.

3. The method of claim 1,
wherein the first recurring expense group corresponds to first expense sequence attributes, and
wherein generating the first prediction comprises:
identifying a second recurring expense group of the plurality of recurring expense groups corresponding to second expense sequence attributes matching the first expense sequence attributes, wherein the second recurring expense group corresponds to a terminated recurring expense sequence.

4. The method of claim 1, further comprising:
training the trained model using historical records each comprising an identifier of a recurring expense subgroup, personal attributes common to the recurring expense subgroup, and an outcome indicating whether the recurring expense sequences of the recurring expense sequence subgroup were successfully extended.

5. The method of claim 4, wherein the first recurring expense group corresponds to first shared expense sequence attributes comprising a first vendor ID of a first vendor, the method further comprising:
identifying, in the historical records, a second recurring expense subgroup with a successful outcome, wherein the second recurring expense subgroup corresponds to second shared expense sequence attributes comprising a second vendor ID of a second vendor in a same industry as the first vendor, and
recommending, to the first recurring expense subgroup, the second vendor as an alternative to the first vendor.

6. The method of claim 4, further comprising:
identifying, in the historical records, one or more successful users each comprised by one or more recurring expense subgroups with a successful outcome, wherein generating the plurality of scores for the plurality of recurring expense subgroups is further based on a proportion of successful users in the respective recurring expense subgroup.

7. The method of claim 1, further comprising:
sending, to the users of the first recurring expense group, a predicted sequence termination message comprising the first prediction and an invitation for the respective user to receive a subgroup contact list comprising contact information of the users in the first recurring expense subgroup; and
generating a modified first recurring expense subgroup by removing, from the first recurring expense subgroup, users who reject the invitation.

8. The method of claim 7, further comprising:
generating a modified plurality of users by removing the users of the modified first recurring expense subgroup from the initial plurality of users;
detecting, in transactions of the modified plurality of users, a modified plurality of open recurring expense sequences each having a plurality of expense sequence attributes;
deriving, using the plurality of expense sequence attributes of the modified plurality of open recurring expense sequences, a modified plurality of recurring expense groups; and
generating a second prediction that the open recurring expense sequences of a second recurring expense group of the plurality of recurring expense groups will terminate within a period of a current period.

9. A system, comprising:
a memory coupled to a computer processor;
a repository configured to store transactions of an initial plurality of users, and a plurality of open recurring expense sequences each having a plurality of expense sequence attributes; and
a subscription renewal engine, executing on the computer processor and using the memory, configured to:
detect, in the transactions of the initial plurality of users, the plurality of open recurring expense sequences,
derive, using the plurality of expense sequence attributes of the plurality of open recurring expense sequences, a plurality of recurring expense groups each comprising a subset of the initial plurality of users,
generate a first prediction that the open recurring expense sequences of a first recurring expense group of the plurality of recurring expense groups will terminate within a period of a current period,
group, using personal attributes of the users in the first recurring expense group, the first recurring expense group into a plurality of recurring expense subgroups,
generate, using a trained model, a plurality of scores for the plurality of recurring expense subgroups each indicating a probability that the open recurring expense sequences of the respective recurring expense subgroup are extendable beyond the current period, and
select, using the plurality of scores for the plurality of recurring expense subgroups, a first recurring expense subgroup to attempt an extension of the open recurring expense sequences of the first recurring expense subgroup.

10. The system of claim 9, wherein the subscription renewal engine is further configured to:
recommend, to the first recurring expense subgroup, a number of periods in the extension of the open recurring expense sequences of the first recurring expense subgroup.

11. The system of claim 9, wherein the first recurring expense group corresponds to first expense sequence attributes, and wherein generating the first prediction comprises:
identifying a second recurring expense group of the plurality of recurring expense groups corresponding to second expense sequence attributes matching the first expense sequence attributes, wherein the second recurring expense group corresponds to a terminated recurring expense sequence.

12. The system of claim 9, wherein the subscription renewal engine is further configured to:
train the trained model using historical records each comprising an identifier of a recurring expense subgroup, personal attributes common to the recurring expense subgroup, and an outcome indicating whether the recurring expense sequences of the recurring expense sequence subgroup were successfully extended.

13. The system of claim 12, wherein the first recurring expense group corresponds to first shared expense sequence attributes comprising a first vendor ID of a first vendor, and wherein the subscription renewal engine is further configured to:
identify, in the historical records, a second recurring expense subgroup with a successful outcome, wherein the second recurring expense subgroup corresponds to second shared expense sequence attributes comprising a second vendor ID of a second vendor in a same industry as the first vendor; and
recommend, to the first recurring expense subgroup, the second vendor as an alternative to the first vendor.

14. The system of claim 12, wherein the subscription renewal engine is further configured to:
identify, in the historical records, one or more successful users each comprised by one or more recurring expense subgroups with a successful outcome, wherein generating the plurality of scores for the plurality of recurring expense subgroups is further based on a proportion of successful users in the respective recurring expense subgroup.

15. The system of claim 8, wherein the subscription renewal engine is further configured to:
send, to the users of the first recurring expense group, a predicted sequence termination message comprising the first prediction and an invitation for the respective user to receive a subgroup contact list comprising contact information of the users in the first recurring expense subgroup, and
generate a modified first recurring expense subgroup by removing, from the first recurring expense subgroup, users who reject the invitation.

16. The system of claim 15, wherein the subscription renewal engine is further configured to:
generate a modified plurality of users by removing the users of the modified first recurring expense subgroup from the initial plurality of users,
detect, in transactions of the modified plurality of users, a modified plurality of open recurring expense sequences each having a plurality of expense sequence attributes,
derive, using the plurality of expense sequence attributes of the modified plurality of open recurring expense sequences, a modified plurality of recurring expense groups, and
generate a second prediction that the open recurring expense sequences of a second recurring expense group of the plurality of recurring expense groups will terminate within a period of a current period.

17. A method comprising:
receiving, from a user and via a graphical user interface (GUI), transactions of the user;
sending the transactions of the user to a subscription renewal engine performing machine learning and configured to:
detect, in transactions of a plurality of users, a plurality of open recurring expense sequences each having a plurality of expense sequence attributes, wherein the plurality of users comprises the user,
derive, using the plurality of expense sequence attributes of the plurality of open recurring expense sequences, a plurality of recurring expense groups each comprising a subset of the plurality of users,
generate a prediction that the open recurring expense sequences of a first recurring expense group of the plurality of recurring expense groups will terminate within a period of a current period,
group, using personal attributes of the users in the first recurring expense group, the first recurring expense group into a plurality of recurring expense subgroups,
generate, using a trained model, a plurality of scores for the plurality of recurring expense subgroups each indicating a probability that the open recurring expense sequences of the respective recurring expense subgroup are extendable beyond the current period,
select, using the plurality of scores for the plurality of recurring expense subgroups, a recurring expense subgroup to attempt extension of the open recurring expense sequences of the recurring expense subgroup, wherein the recurring expense subgroup comprises the user, and
send, to the user and via the GUI, a predicted sequence termination message comprising the first prediction and an invitation for the user to receive a subgroup contact list comprising contact information of the users in the first recurring expense subgroup;
receiving, from the subscription renewal engine and via the GUI, the predicted sequence termination message; and
displaying, in an element within the GUI generated by a computer processor, the predicted sequence termination message.

18. The method of claim 17, wherein the subscription renewal engine is further configured to:
recommend, to the recurring expense subgroup, a number of periods in the extension of the open recurring expense sequences of the recurring expense subgroup.

19. The method of claim 17, wherein the first recurring expense group corresponds to first expense sequence attributes, and wherein generating the prediction comprises:
identifying a second recurring expense group of the plurality of recurring expense groups corresponding to second expense sequence attributes matching the first expense sequence attributes, wherein the second recurring expense group corresponds to a terminated recurring expense sequence.

20. The method of claim 17, wherein the subscription renewal engine is further configured to:
train the trained model using historical records each comprising an identifier of a recurring expense subgroup, personal attributes common to the recurring expense subgroup, and an outcome indicating whether the recurring expense sequences of the recurring expense sequence subgroup were successfully extended.
